(19) United States
(12) Patent Application Publication
(10) Pub. No.: US 2008/0040404 A1
(43) Pub. Date: Feb. 14, 2008

(54) Host computer I/O filter re-directing potentially conflicting I/O commands from instantiations of legacy application

(75) Inventors: Neal Robert Christiansen, Bellevue, WA (US); Venkataraman Ramanathan, Sammamish, WA (US); Apurva Ashwin Doshi, Seattle, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/503,460

(22) Filed: Aug. 11, 2006

(51) Int. Cl. G06F 17/30

(52) U.S. Cl. 707/205

(57) ABSTRACT

A host computing device has multiple instantiated copies of a legacy application. Each copy may issue a data request to access data at an absolute location common to all of the copies. To respond to the data request from a particular copy, it is determined that the absolute location of the data request has a redirection device specifying an alternate location, and the data request is dishonored. A unique location is determined from the alternate location and a unique ID of the particular copy of the legacy application, and the data request is re-issued to access the data at the unique location. Data requests from different copies of the legacy application are thus directed to different unique locations.

### TECHNICAL FIELD

The present invention relates to a host computer upon which an application is instantiated a plurality of times. In particular, the present invention relates to such a host computer where each instantiation of the application can issue an I/O command that at least potentially conflicts with another instantiation of the application. More particularly, the present invention relates to an I/O filter that receives the I/O command and redirects same in a manner so as to avoid the potential conflict.

### BACKGROUND OF THE INVENTION

As may be appreciated, in at least some computer settings, a computing device may be arranged to act as a host for multiple processing environments. For example, such a host computing device may be a terminal server or the like that provides workspaces and computing services for each of a plurality of clients, or may be a virtual server or the like upon which is running a plurality of virtual machines. In either case, the host presumably includes sufficient processing power to service each process of each client or of each virtual machine and to otherwise perform all necessary managerial functions, including housekeeping, maintenance, and the like.

As may also be appreciated, an application in the normal course of being instantiated and functioning on any computing device may from time to time issue an input/output (‘I/O’) command with regard to the computing device. For example, the I/O command may be to open a file, read from or write to such an opened file, open a data store such as a registry, read from or write to such an opened data store, and the like. As may be appreciated, each I/O command from any particular application is with regard to a location at which data is stored or is to be stored, and is issued by the application to the computing device upon which such application is instantiated.

In relatively newer applications, the location of each I/O command is specified in a relative form, and the computing device of the application is expected to derive an absolute form for the location based on the relative form, the application, the user of the application, and/or the like. One example of such a relative form for a location of an I/O command is a virtual address that is issued by an application and that is converted into a physical address (i.e., the absolute form of the location) by an address translator of a corresponding computing device. Another example of such a relative form for a location is a mapped network drive of the computing device that is in reality a data set (i.e., the absolute form of the location) on a physical server. As may be appreciated, by having an application specify a location in such a relative form, the computing device upon which the application is instantiated is given at least some flexibility to change the absolute form of the location as may be necessary for efficiency and to address changed circumstances and the like.

Correspondingly, in relatively older ‘legacy’ applications, the location of each I/O command may not be specified in a relative form but instead may be specified directly in an absolute form. Thus, the application may specify a physical address and not a virtual address, or may specify a data set and not a mapped network drive, as with the examples immediately above.

Notably, such legacy applications specifying locations in absolute form present a concern when instantiated on the aforementioned host, especially if the host has a plurality of instantiated copies of a particular application, and each copy of the application is issuing conflicting I/O commands with regard to the same location based on the same absolute form of such location. In particular, and as an example of such conflicting I/O commands, a first copy of the application may write first data to the location, and a second copy of the application may overwrite the first data of the first copy at the location with second data. As a result of such conflicting I/O commands, the first copy may later read what is believed to be the first data of such first copy from the location, but which is actually the second data of the second copy.

As a more concrete example, presume that a legacy application is programmed to write a certain type of data to a file WBPA.DAT at an absolute C:\DATA\. Further, presume that a host is a terminal server running workspaces for first and second clients, and that each of the clients have chosen to instantiate the legacy application in the respective workspace thereof on the terminal server host. Thus, the first client has a corresponding first instantiated copy of the application in a corresponding first workspace on the terminal server host, and the second client has a corresponding second instantiated copy of the application in a corresponding second workspace on the terminal server host.

Now, if each of the first and second copies of the applications on the terminal server host is writing data to the same C:\DATA\WBPA.DAT of the terminal server host, and each of the first and second copies of the applications is presuming that no other entity is also writing data to such C:\DATA\WBPA.DAT, then it is a virtual certainty that such C:\DATA\WBPA.DAT will be unintentionally corrupted with conflicting data from both copies of the application, presuming that the terminal server contains no intervening utility that would obviate such an occurrence. Hence, a need exists for such a utility that prevents such a conflict when multiple copies of a legacy application at a host each write to a location specified as an absolute form. In particular, a need exists for a filter at the host that in effect redirects the data from each copy of the application to an unique location specific to such copy, specific to a user using the copy, specific to a terminal at which such a user is located, or the like.

### SUMMARY OF THE INVENTION

The aforementioned need is satisfied by the present invention in which a method is provided with regard to a host computing device having a plurality of instantiated copies of a legacy application thereon, where each copy of the legacy application is in a differing workspace and has a unique ID associated therewith, and where each copy of the legacy application at least potentially issues a data request to access data at an absolute location of the host common to all of the copies of the legacy application at the host. The method is for responding to the data request from a particular copy of the legacy application having a particular unique ID.

In the method, it is determined that the absolute location of the data request has a redirection device corresponding thereto, where the redirection device specifies an alternate location of the host that is to be employed instead of the absolute location, and the data request is therefore dishonored based on the redirection device. In addition, a unique location of the host is determined based on the alternate location of the redirection device and the particular unique ID of the particular copy of the legacy application, and the data request is re-issued to access the data at the unique location of the host. Thus, for each different instantiated copy of the legacy application at the host, data requests therefrom are not directed to the same absolute location but instead to the unique location that corresponds to the copy.

### BRIEF DESCRIPTION OF THE DRAWINGS

The foregoing summary, as well as the following detailed description of the embodiments of the present invention, will be better understood when read in conjunction with the appended drawings. For the purpose of illustrating the invention, there are shown in the drawings embodiments which are presently preferred. As should be understood, however, the invention is not limited to the precise arrangements and instrumentalities shown. In the drawings:

FIG. 1 is a block diagram representing a general purpose computer system in which aspects of the present invention and/or portions thereof may be incorporated;

FIG. 2 is a block diagram showing an input/output (I/O) stack of a computing device including a number of filters;

FIG. 3 is a block diagram showing a computing device such as the computing device having the I/O stack shown in FIG. 2, where the computing device is a host for a number of clients, and where each client has a workspace within which a copy of an application may be instantiated;

FIG. 4 is a block diagram showing the I/O stack of FIG. 2 in the host of FIG. 3 with a fanning filter for ensuring that each copy of the application of FIG. 3 references a unique location when opening a file, in accordance with embodiments of the present invention; and

FIG. 5 is a flow diagram showing key step performed by the fanning filter of FIG. 4 in accordance with embodiments of the present invention.

### DETAILED DESCRIPTION OF THE INVENTION

### Computer Environment

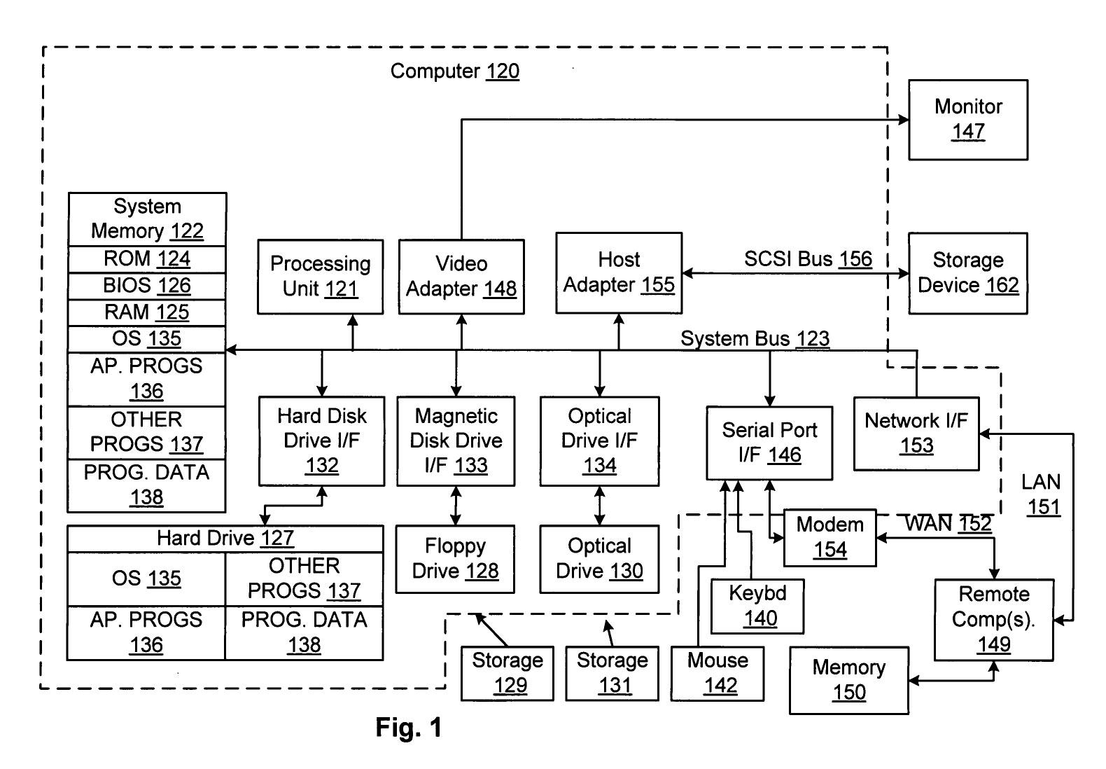

FIG. 1 and the following discussion are intended to provide a brief general description of a suitable computing environment in which the present invention and/or portions thereof may be implemented. Although not required, the invention is described in the general context of computer-executable instructions, such as program modules, being executed by a computer, such as a client workstation or a server. Generally, program modules include routines, programs, objects, components, data structures and the like that perform particular tasks or implement particular abstract data types. Moreover, it should be appreciated that the invention and/or portions thereof may be practiced with other computer system configurations, including hand-held devices, multi-processor systems, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

As shown in FIG. 1, an exemplary general purpose computing system includes a conventional personal computer 120 or the like, including a processing unit 121, a system memory 122, and a system bus 123 that couples various system components including the system memory to the processing unit 121. The system bus 123 may be any of several types of bus structures including a memory bus or memory controller, a peripheral bus, and a local bus using any of a variety of bus architectures. The system memory includes read-only memory (ROM) 124 and random access memory (RAM) 125. A basic input/output system 126 (BIOS), containing the basic routines that help to transfer information between elements within the personal computer 120, such as during start-up, is stored in ROM 124.

The personal computer 120 may further include a hard disk drive 127 for reading from and writing to a hard disk (not shown), a magnetic disk drive 128 for reading from or writing to a removable magnetic disk 129, and an optical disk drive 130 for reading from or writing to a removable optical disk 131 such as a CD-ROM or other optical media. The hard disk drive 127, magnetic disk drive 128, and optical disk drive 130 are connected to the system bus 123 by a hard disk drive interface 132, a magnetic disk drive interface 133, and an optical drive interface 134, respectively. The drives and their associated computer-readable media provide non-volatile storage of computer readable instructions, data structures, program modules and other data for the personal computer 120.

Although the exemplary environment described herein employs a hard disk, a removable magnetic disk 129, and a removable optical disk 131, it should be appreciated that other types of computer readable media which can store data that is accessible by a computer may also be used in the exemplary operating environment. Such other types of media include a magnetic cassette, a flash memory card, a digital video disk, a Bernoulli cartridge, a random access memory (RAM), a read-only memory (ROM), and the like.

A number of program modules may be stored on the hard disk, magnetic disk 129, optical disk 131, ROM 124 or RAM 125, including an operating system 135, one or more application programs 136, other program modules 137 and program data 138. A user may enter commands and information into the personal computer 120 through input devices such as a keyboard 140 and pointing device 142. Other input devices (not shown) may include a microphone, joystick, game pad, satellite disk, scanner, or the like. These and other input devices are often connected to the processing unit 121 through a serial port interface 146 that is coupled to the system bus, but may be connected by other interfaces, such as a parallel port, game port, or universal serial bus (USB). A monitor 147 or other type of display device is also connected to the system bus 123 via an interface, such as a video adapter 148. In addition to the monitor 147, a personal computer typically includes other peripheral output devices (not shown), such as speakers and printers. The exemplary system of FIG. 1 also includes a host adapter 155, a Small Computer System Interface (SCSI) bus 156, and an external storage device 162 connected to the SCSI bus 156.

The personal computer 120 may operate in a networked environment using logical connections to one or more remote computers, such as a remote computer 149. The remote computer 149 may be another personal computer, a server, a router, a network PC, a peer device or other common network node, and typically includes many or all of the elements described above relative to the personal computer 120, although only a memory storage device 150 has been illustrated in FIG. 1. The logical connections depicted in FIG. 1 include a local area network (LAN) 151 and a wide area network (WAN) 152. Such networking environments are commonplace in offices, enterprise-wide computer networks, intranets, and the Internet.

When used in a LAN networking environment, the personal computer 120 is connected to the LAN 151 through a network interface or adapter 153. When used in a WAN networking environment, the personal computer 120 typically includes a modem 154 or other means for establishing communications over the wide area network 152, such as the Internet. The modem 154, which may be internal or external, is connected to the system bus 123 via the serial port interface 146. In a networked environment, program modules depicted relative to the personal computer 120, or portions thereof, may be stored in the remote memory storage device. It will be appreciated that the network connections shown are exemplary and other means of establishing a communications link between the computers may be used.

### I/O Filters

In a contemporary operating system such as MICROSOFT Corporation's WINDOWS XP operating system with an underlying file system such as the WINDOWS NTFS (NT File System), FAT, CDFS, SMB redirector file system, or WebDav file systems, one or more file system filter drivers may be inserted between an I/O (Input/Output) manager that receives user I/O requests and a file system driver. In general, filter drivers or ‘filters’ are processes or components that enhance the underlying file system by performing various file-related computing tasks that users desire, including tasks such as passing file system I/O (requests and data) through antivirus software, file system quota providers, file replicators, encryption/compression products, and the like.

For example, an antivirus product may provide a filter that watches I/O to and from certain file types (.exe, .doc, and the like) looking for virus signatures, while a file replication product may provide a filter that performs file system-level mirroring. Other examples of types of file system filters include filters directed to system restoration, disk quota enforcement, backup of open files, un-deletion of deleted files, encryption of files, and the like. In general, by installing file system filters, a computer user can select and effectuate desired file system features in a manner that enables upgrades, replacement, insertion, and removal of each filter without changing the operating system or file system driver.

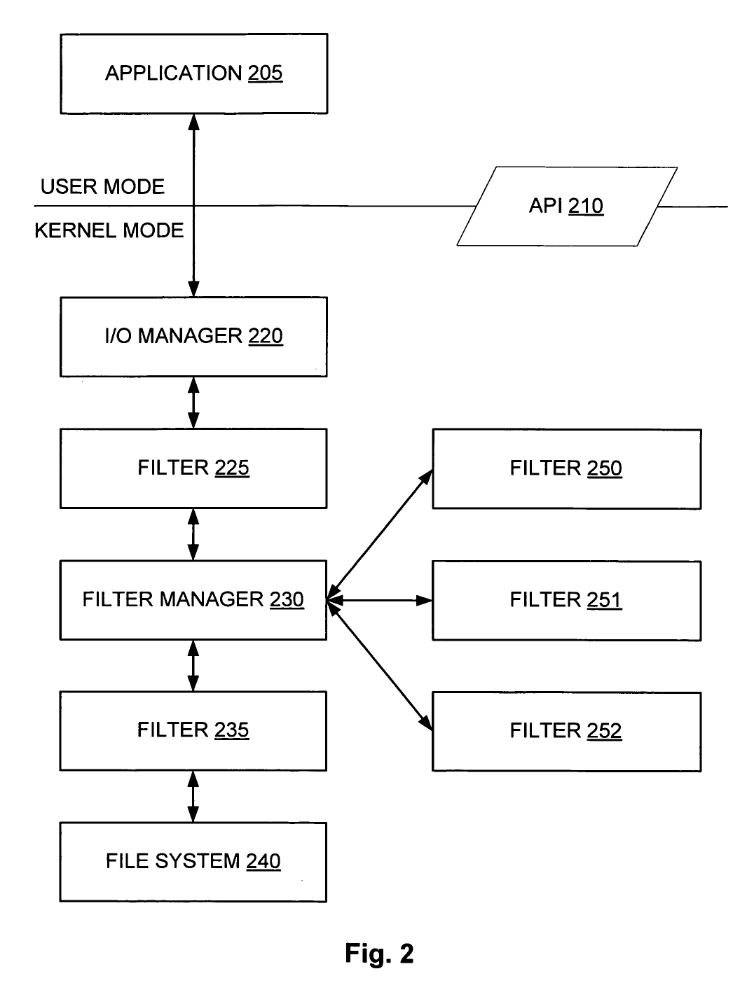

Turning now to FIG. 2, a system in which aspects of the subject matter described herein may operate is shown. The components include one or more applications 205, an applications programming interface (API) 210, an input/output (I/O) manager 220, a filter manger 230, a file system 240, and one or more ‘legacy’ filters 225, 235 and/or ‘minifilters’ 250-252. In this configuration, some filters are associated with the filter manager 230 while other filters are not. The filter manager 230 is placed in a stack with other filters (e.g., filters 225 and 235).

Each application 205 may from time to time issue a file system request, for example by way of a function or method call, through the API 210 to the I/O manager 220. The I/O manager 220 may then determine what I/O request or requests should be issued to fulfill the file system request and send each I/O request down the file system stack which may include filters 225 and/or 235 and filter manager 230. The I/O manager 220 may also return data to the application 205 as operations associated with the file system request proceed, complete, abort, or the like. Note that all filters are optional in that each such filter need not necessarily operate on any particular I/O request. Note too that the filter manager 230 is itself a filter whose purpose is to provide an interface for writing file system filters, and is designed to allow the use of both legacy filters and minifilters that use the filter manager 230.

As may be appreciated, at least some of the filters of FIG. 2 when instantiated register with a registration mechanism in the filter manager 230. Principally, such registered filters include the minifilters, and are sometimes referred to as managed filters. For efficiency, each managed filter typically registers only for I/O requests in which such filter may have an interest, such as for example, create, read, write, cleanup, close, rename, set information, query information, and the like. As one example, an encryption filter may register for read and write I/O requests, but not for other I/O requests where data does not need to be encrypted or decrypted.

A managed filter may also specify whether such filter should be notified for pre-callbacks and post-callbacks for each type of I/O request. A pre-callback is called as data associated with an I/O request propagates from the I/O manager 220 towards the file system 240, while a post-callback is called during the completion of the I/O request as data associated with the I/O request propagates from the file system 240 towards the I/O manager 220.

From each I/O request, the filter manager 230 may create a data structure in a uniform format suitable for use by the managed filters including minifilters 250-252. Hereinafter, this data structure is sometimes referred to as callback data. The filter manager 230 may then call and pass the callback data or a reference thereto to each filter that has registered to receive a callback for the type of I/O received by the filter manager 230. Any filter registered to receive callbacks for the type of I/O request received by the filter manager 230 may be referred to as a registered filter.

Typically, the filter manager 230 passes callback data associated with a particular type of I/O request to each registered filter sequentially in a predetermined order. For example, if the minifilters 250 and 252 are sequentially ordered to receive callbacks for all read I/O requests, then after receiving a read I/O request, the filter manager 230 first passes the callback data to the filter 250 and after the filter 250 has processed the callback data, the filter manager 230 then passes the callback data as modified if at all to the filter 252.

A filter may be attached to one or more volumes. That is, a filter may be registered to be called and receive callback data for I/O requests related to only one volume or to more than one volume.

A filter may generate its own I/O request which may then be passed to other filters. For example, an antivirus filter may wish to read a file before such file is opened. A filter may stop an I/O request from propagating further and may report a status code such as success or failure for the I/O request. A filter may store data in memory and persist the stored data. In general, a filter may be created to perform any set of actions that may be performed by a kernel-mode or user-mode process and may be reactive, for example waiting until an I/O request is received before acting, and/or proactive, for example initiating I/O requests or performing other actions asynchronously with regard to I/O requests handled by the I/O manager 220.

As set forth above, the filter manager 230 may be placed in a stack with other legacy filters such as the filters 225 and 235. Each legacy filter 225, 235 in the stack may process I/O requests and pass the requests to another filter or other component in the stack. For example, in response to a read request received from an application 205, the I/O manager 220 may send an I/O request to the filter 225, which in turn may examine the I/O request and determine that such I/O request is not of interest and thereafter pass the I/O request unchanged to the filter manager 235. If any registered minifilter is interested in the I/O request, the filter manager 230 may then pass callback data to such interested filter. After each interested registered filter has examined and acted on the callback data, the filter manager 230 may then pass the I/O request to the filter 235. The filter 235 may then perform some action based on the I/O request and may then pass the I/O request to the file system 240.

The file system 240 services the I/O request and passes a result to the filter 235. Typically, the result passes in an order reverse from that in which the I/O request proceeded, which here would be first to filter 235, then to filter manager 230, which may send callback data to each interested registered filter, and then to filter 225. Each filter may examine the result and perhaps perform an action based thereon before passing the result onward.

### Copies of Legacy Application Instantiated on Host

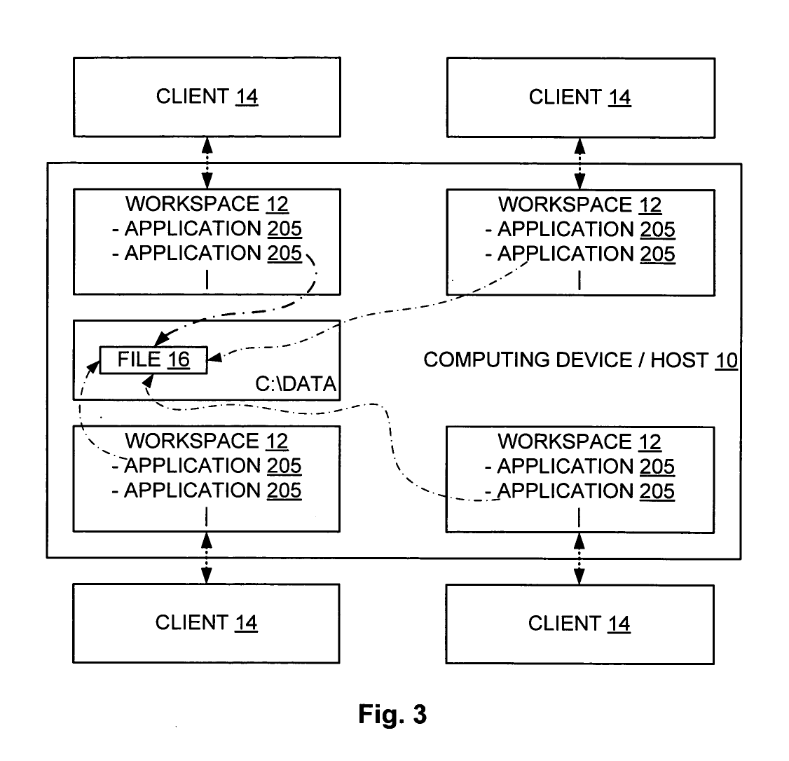

Turning now to FIG. 3, it is seen that a computing device 10 is arranged to act as a host for multiple processing environments. As was set forth above, examples of such a host 10 include a terminal server or the like that provides workspaces 12 and computing services for each of a plurality of clients 14, and also a virtual server or the like upon which is running a plurality of virtual machines 12. In either case, the host 10 includes sufficient processing power to service each process of each workspace/virtual machine 12 (hereinafter, ‘workspace 12’). Likewise, the host 10 includes sufficient processing power to perform necessary managerial functions, including housekeeping, maintenance, and the like. Such a host 10 acting as a terminal server, a virtual server, or the like is generally known or should be apparent to the relevant public and therefore need not be set forth herein in any detail except for that which is provided. Thus, such a host 10 may be any appropriate host without departing from the spirit and scope of the present invention.

In a manner similar to that which was set forth above, each workspace 12 of the host 10 of FIG. 3 may have instantiated therein on or more applications 205. Each application 205 in the normal course of operation may itself issue a file system request or the like that results in one or more I/O requests at the host 10, such as those that were discussed above in connection with FIG. 2. For example, the file system request may be to open a file, read from or write to such an opened file, or the like. In a similar manner, each application 205 may issue other data requests or the like that each result in one or more I/O requests or the like that are not necessarily directed toward the file system 240. For example, the other data request may be to open a data store such as a registry, read from or write to such an opened data store, and the like. As may be appreciated, such other data request may be handled by the same stack as that which handles a file system request, or may be handled by another stack, or may be handled by another structure or device. For purposes of the present invention, however, it is to be presumed that regardless of the stack, structure, or device handling the issued request, such stack, structure, or device includes filters or filter-like components.

At any rate, each file system or other data request (hereinafter, ‘request’) from any particular application 205 of any particular workspace 12 is with regard to a location at which data is stored or is to be stored, and the request as issued by the application 205 is processed at the host 10 upon which such application 205 is instantiated. Thus, such host 10 includes a stack or the like such as that shown in FIG. 2 with appropriate filters for processing the request to the specified location thereof, be it directed toward a file system 240, a data store, a registry, or the like.

As was set forth above, each application 205 may be a relatively newer application 205 that can specify each location in a relative form, or may be a relatively older ‘legacy’ application 205 that can only specify each location in an absolute form. As should be understood, an application 205 that specifies a location in a relative form expects the host 10 to derive an absolute form for the location based on the relative form, the application, the user of the application, the client 14, and/or the like. Such host 20 may derive the absolute form from the relative form in any appropriate manner without departing from the spirit and scope of the present invention. Presumably, the host 20 would employ an appropriate filter to derive the absolute form for the location from the relative form, such as one of the filters set forth in connection with FIG. 2, either in connection with a file system manager 230, another manager (not shown), or the like. Doing so is generally known or should be apparent, and therefore need not be set forth herein in any detail.

One example of such a relative form for a location of an I/O command is a virtual address that is issued by an application and that is converted into a physical address (i.e., the absolute form of the location) by an address translator of the host 10. Another example of such a relative form for a location is a mapped network drive of the computing device that is in reality a data set (i.e., the absolute form of the location) on a physical server. Yet another example of such a relative form for a location is a location described according to a wild card, such as %homedrive%, %homepath%, %systemroot%, or the like. In such example, and as should be appreciated, %homedrive%\data\log\ would be resolved to c:\data\log\ if in fact %homedrive% was determined to be c:. As may be appreciated, specifying a location in a relative form provides flexibility in allowing the location to be resolved to different absolute forms based on different circumstances, such as for example different users, different clients 14, etc.

Correspondingly, specifying a location directly in the absolute form thereof, as is the case with a legacy application 205, provides no flexibility in allowing the location to be resolved differently based on different circumstances. Most notably, the inflexibility a legacy application 205 in specifying a location according to the absolute form thereof presents an issue in the circumstance where multiple copies of such legacy application 205 are instantiated in different workspaces 12 on a host 10, and yet all of the instantiated copies of the application 205 reference the same absolute location when performing a data request. In particular, and as should be appreciated, all of the instantiated copies of the application 205 referencing the same absolute location will result in conflict and in corrupted data.

Specifically, and as seen in FIG. 3, if each copy of the legacy application 205 is programmed to write a certain type of data to a file 16 at an absolute location of the host 10 such as C:\DATA\, then a first copy of the legacy application 205 in a first workspace 12 will write such data to such file 16 at such absolute location, a second copy of the legacy application 205 in a second workspace 12 will write such data to the same file 16 at the same absolute location, and so on. As should be evident, and presuming that each copy of the legacy application 205 is unaware of the situation, the same file 16 at the same location of the host 10 unintentionally receiving data from multiple copies of the legacy application 205 will result in such file becoming hopelessly corrupted with conflicting data from both copies of the legacy application 205.

### Fanning Filter

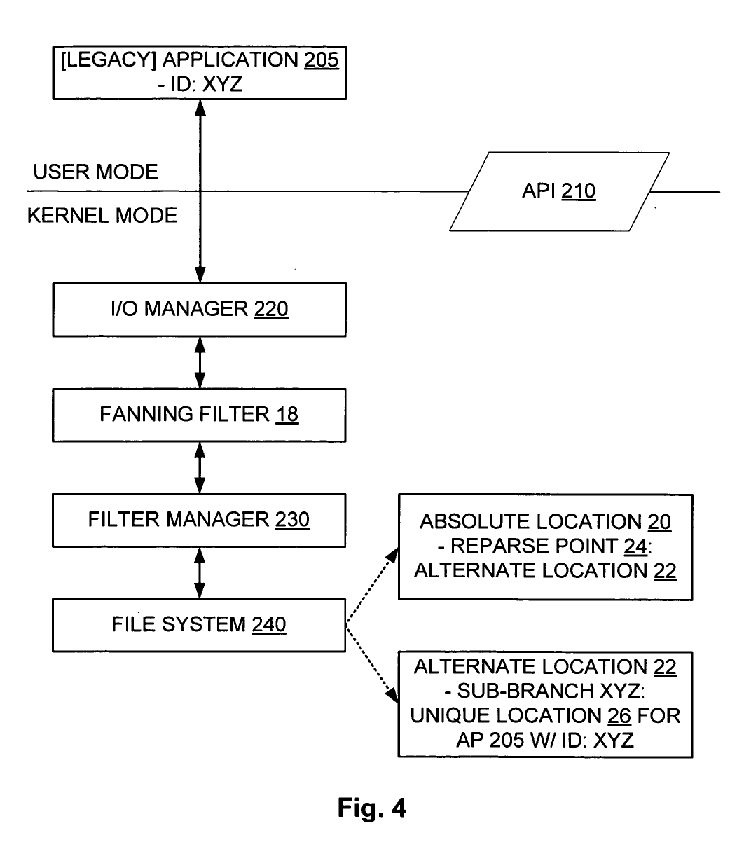

In one embodiment of the present invention, then, and in the situation where multiple copies of a legacy application 205 are instantiated in respective workspaces 12 of a host 10 and all of the copies reference the same file 16 at the same absolute location when performing a data request, the data requests from each copy of the legacy application 205 are fanned out to files 16 at unique non-conflicting locations. In particular, and turning now to FIG. 4, in the present invention, a fanning filter 18 is provided in the stack of FIG. 2 or the like, where the fanning filter 18 functions both to redirect each such data request away from the absolute location 20 thereof and also to specify a corresponding unique location 26. Note that the fanning filter 18 as shown in FIG. 4 is in-line with the stack and is the only filter shown, although the fanning filter 18 may also be accompanied by other filters and itself may be external from the main thrust of the stack, all without departing from the spirit and scope of the present invention. Thus, the fanning filter 18 may be implemented as a legacy filter or as a minifilter.

In one embodiment of the present invention, an absolute location 20 of the host 10 that should not in fact be employed by a legacy application 205 is noted as such by including with or attaching to such absolute location 20 a redirection device, such as for example a reparse point 24. As is known or should be apparent, such a reparse point 24 or other redirection device is essentially an instruction that specifies an alternate location 22 that should be employed rather than the absolute location 20 at issue. Typically, encountering and employing a reparse point 24 is transparent to the application 205 that issued the data request that caused such reparse point 24 to be encountered. For example, if the reparse point is encountered as part of a data request to open a file 16 at the absolute location 20, the return to such a data request is a handle, which the application 205 presumes is to the file 16 at the absolute location 20 but which in actuality can be to the file 16 at any location including an alternate location 22 as referenced in a corresponding reparse point 24 at the aforementioned absolute location 20.

Essentially, then, the fanning filter 18 of the present invention with the aid of a reparse point 24 at an absolute location 20 ‘retrofits’ a legacy application 205 so that each copy of the legacy application 205 at the host 10 is provided with a unique location 26 based on the alternate location 22 set forth in the reparse point 24. Note here that such unique location 26 may be selected based on any appropriate characteristic that serves to distinguish each copy of the legacy application 205 without departing from the spirit and scope of the present invention. For example, a unique location 26 may be selected based on an ID uniquely associated with each copy of the legacy application 205, where the unique ID may be the ID of the copy, the ID of the user of the copy, the ID of the corresponding client 14, and the like.

In one embodiment of the present invention, it is presumed that the alternate location 22 set forth in the reparse point 24 is defined in a hierarchical manner. For example, the alternate location 22 may be a directory, branch, or the like, which may in turn be a sub-directory of another directory or a sub-branch of another branch, and which itself can include one or more sub-directories or sub-branches, as the case may be. In such embodiment, then, the fanning filter 18 for any particular copy of a legacy application determines the unique location 26 thereof based on the alternate location 22 specified in the reparse point 24 for the absolute location 20 specified by the copy, and also based on the unique ID associated with the copy, where the unique ID is employed to specify a sub-directory or sub-branch of the alternate location 22 as the unique location 26 for the copy.

For example, if a legacy application 205 specifies that a particular file 16 thereof is to be stored at an absolute location 20 such as C:\DATA, and such absolute location 20 has a reparse point 24 that specifies F:\SHARE as an alternate location 22, and if the unique ID of the copy is specified as the user ID USER_A of the user of such copy, then the fanning filter would combine F:\SHARE as the alternate location 22 and USER_A as the unique ID of the copy to produce F:\SHARE\USER_A as the unique location 26 to be employed to store the file 16 for the legacy application 205. Note here that it may be the case that a reparse point 24 for an absolute location 20 may specify such absolute location 20 as the alternate location 22, in which case the unique location 26 would be a sub-directory of the absolute location 20. In either case, however, each copy of the legacy application 205 is provided with a unique and different location 26 to store the file 16 thereof, where each unique location 26 is fanned out from the alternate location 22, with the result being that no conflicts as between copies should arise.

It is to be appreciated that to effectuate the present invention, each absolute location 20 of the host 10 referenced by each legacy application 205 of the host 10 requires a corresponding reparse point 24 or the like. Creating each such reparse point 24 or the like and attaching same to the corresponding absolute location 20 may be performed in any appropriate manner without departing from the spirit and scope of the present invention. For example, the host 10 may include or have access to an appropriate administrative or maintenance utility for creating and attaching each reparse point 24 as necessary.

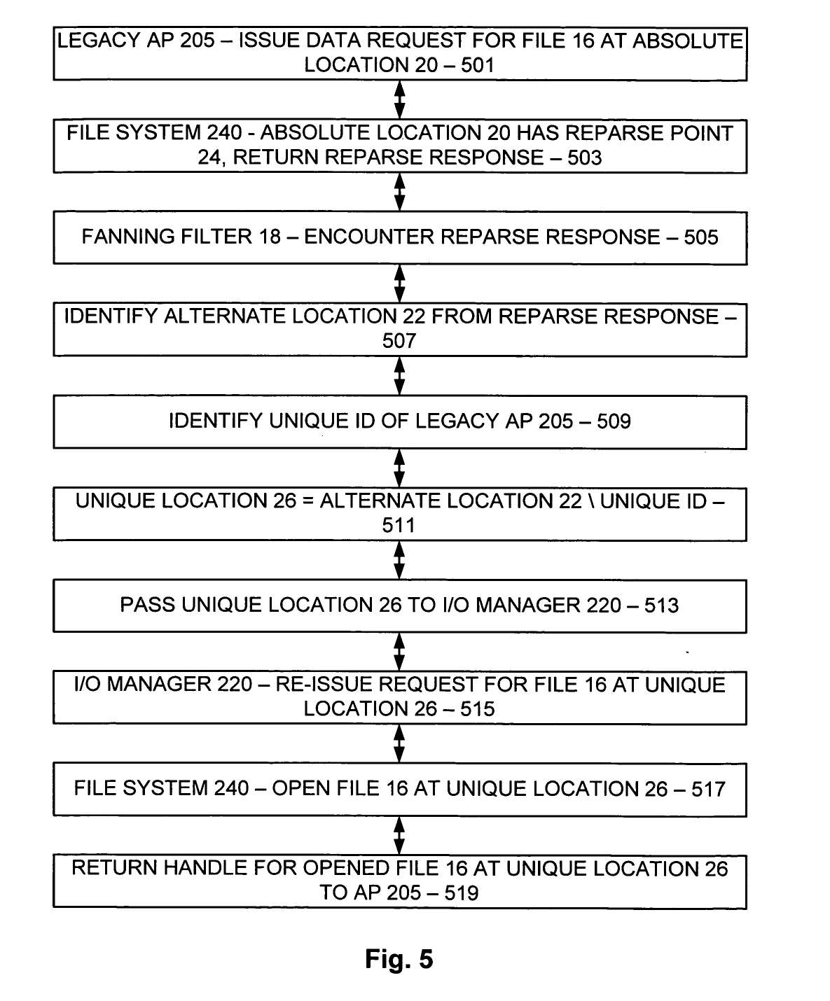

Turning now to FIG. 5, it is seen that in one embodiment of the present invention, a fanning filter 18 in an I/O stack or the like at a host 10 employs a reparse point 24 of an absolute location 20 referenced by a copy of a legacy application 205 instantiated at the host 10 to determine a corresponding unique location 26 for the copy of the legacy application 205, in the following manner. Preliminarily, it is presumed that the legacy application 205 issues a data request with regard to a file 16 (INFO.TXT, e.g.) at an absolute location 20 (C:\DATA, e.g.) (step 501) and that as part of servicing the data request the file 16 is to be opened at the absolute location 20 by way of an appropriate (first) I/O request at an I/O stack such as that shown in FIG. 4. Thus, the first I/O request may pass from an I/O manager 220 toward a file system 240 by way of the fanning filter 18.

Typically, the file system 240 upon receiving the first I/O request to open the file 16 at the absolute location 20 notes that the absolute location 20 has an attached reparse point 24, and therefore does not honor such first I/O request but instead returns a reparse response (step 503). Typically, such reparse response is in the nature of an error response, and at any rate would identify the reparse point 24 and/or would include the data of the reparse point 24, including the alternate location (C:\DATA\REPARSE, e.g.).

Significantly, in one embodiment of the present invention, the fanning filter 18 is registered such that the reparse response from the file system 240 is passed to such fanning filter 18. Thus, upon encountering the reparse response (step 505), the fanning filter 18 identifies the alternate location 22 therein (step 507) and also identifies the unique ID of the copy of the legacy application 205 that initiated the data request (the aforementioned USER_A, e.g.) (step 509). Note that such unique ID of the copy of the legacy application 205 may be identified in any appropriate manner without departing from the spirit and scope of the present invention. For example, the fanning filter may have access to the unique ID based on data maintained by the host 10.

At any rate, with the identified alternate location 22 and the identified unique ID, the fanning filter determines a unique location 26 as a sub-directory of the identified alternate location 22, where the name of the sub-directory is the identified unique ID (C:\DATA\REPARSE\USER_A, e.g.) (step 511), and passes such determined unique location 26 back to the I/O manager 220 as part of a request to ignore the first I/O request and instead issue a second I/O request based on the first I/O request (step 513). As may now be appreciated, the second I/O request is substantively identical to the first I/O request, except that the file is to be opened at the determined unique location 26 and not the absolute location 20 or at the alternate location 22.

As should be understood, based on the second I/O request, and presuming that no unusual conditions exist, the second I/O request passes from the I/O manager 220 to the file system 240 (step 515), where the file system 240 in response thereto in fact opens the file 16 at the unique location 26 (step 517) and returns a handle or the like to the opened file 16 at the unique location 26 to the requesting application 205 by way of the I/O manager 220. Thus, the application 205 may then employ the handle to access the file 16 at the unique location 26 (step 519).

Notably, the process of altering the location of the file 16 is entirely transparent to the legacy application 205. That is, although the file 16 was requested to be opened at the absolute location 20 but instead was opened at the unique location 26, the application 205 in receiving the handle to the file 16 is only concerned that the handle in fact accesses the opened file 16. Thus, although the file 16 is opened at the unique location 26 and not the absolute location 20, as was requested by the legacy application 205, such legacy application 205 is not adversely affected. More importantly, by using the unique location 26 and not the absolute location 20, conflicts between multiple copies of the legacy application 205 at the host are avoided, and data in files 16 are not corrupted because each copy of the legacy application 205 employs a separate location for the files 16 thereof.

In the present invention as thus far set forth, the fanning filter 18 employs a reparse point 24 or the like as received from a file system 240 to redirect a request to open a file 16. Note, though, that in at least some systems the file system 240 is not capable of employing such a reparse point 24. Note, too, that in at least some systems the request is not directed to a file system 240 but instead is directed to an alternate data source such as a data store, a registry, or the like. In either case, and in an alternate embodiment of the present invention, a reparse point 24 is not obtained from a file system 240 or the like. Instead, in such alternate embodiment, the fanning filter 18 accesses a mapping conversion table or the like with information akin to that which is available from a reparse point 24. Thus, and as should be appreciated, for each of several absolute locations 20, the mapping conversion table or the like would include a corresponding relative location 22, and the fanning filter 18 would refer to the mapping conversion table before opening each file 16 to determine whether an alternate location 22 is to be employed rather than the absolute location 20 specified.

### Conclusion

The programming necessary to effectuate the processes performed in connection with the present invention is relatively straight-forward and should be apparent to the relevant programming public. Accordingly, such programming is not attached hereto. Any particular programming, then, may be employed to effectuate the present invention without departing from the spirit and scope thereof.

In the foregoing description, it can be seen that the present invention comprises a new and useful fanning filter 18 that prevents a conflict when multiple copies of a legacy application 205 at a host 10 each write to a location 20 specified as an absolute form. The fanning filter 18 at the host 10 in effect redirects data from each copy of the application 205 to a unique location 26 specific to such copy, specific to a user using the copy, specific to a terminal at which such a user is located, or the like.

It should be appreciated that changes could be made to the embodiments described above without departing from the inventive concepts thereof. As but one example, although the present invention is primarily set forth in terms of a file 16 being opened at a file system location, the present invention is equally applicable to a sub-directory or directory being opened at the file system location. Similarly, the present invention is equally applicable to a registry entry being opened within a registry by way of an appropriate stack or the like, a data store entry being opened within a data store by way of an appropriate stack or the like, and the like. It should be understood, therefore, that this invention is not limited to the particular embodiments disclosed, but it is intended to cover modifications within the spirit and scope of the present invention as defined by the appended claims.

1. A method with regard to a host computing device having a plurality of instantiated copies of a legacy application thereon, each copy of the legacy application being in a differing workspace and having a unique ID associated therewith, each copy of the legacy application at least potentially issuing a data request to open a file at an absolute location of the host common to all of the copies of the legacy application at the host, the method for responding to the data request from a particular copy of the legacy application having a particular unique ID and comprising:
determining that the absolute location of the data request has a redirection device corresponding thereto, the redirection device specifying an alternate location of the host that is to be employed instead of the absolute location;
dishonoring the data request based on the redirection device;
determining a unique location of the host based on the alternate location of the redirection device and the particular unique ID of the particular copy of the legacy application; and
re-issuing the data request to open the file at the unique location of the host,
whereby for each different instantiated copy of the legacy application at the host, data requests therefrom are not directed to the same absolute location but instead to the unique location that corresponds to the copy.

2. The method of claim 1 comprising:
generating a first I/O request corresponding to the data request at an I/O manager, the first I/O request including an identification of the file and the absolute location thereof from the data request;
receiving the generated first I/O request at a file system and determining at the file system that the absolute location of the received first I/O request has a redirection device corresponding thereto, the redirection device specifying an alternate location of the host that is to be employed instead of the absolute location;
dishonoring the received first I/O request at the file system based on the redirection device corresponding to the absolute location of the received first I/O request, and returning a redirection response including the alternate location of the redirection device;
receiving the returned redirection response at a fanning filter, identifying at the fanning filter the alternate location in the received redirection response, and also identifying the particular unique ID of the particular copy of the legacy application that issued the data request;
determining at the fanning filter a unique location of the host based on the identified alternate location and the identified unique ID, and passing the determined unique location to the I/O manager as a request to ignore the first I/O request and instead generate a second I/O request based on the first I/O request; and
generating at the I/O manager the second I/O request to include the identification of the file and the unique location;
whereby for each different instantiated copy of the legacy application at the host, data requests therefrom are not directed to the same absolute location but instead to the unique location that corresponds to the copy.

3. The method of claim 2 comprising determining at the fanning filter the unique location as a branch of the identified alternate location, the branch having the identified unique ID as the name thereof.

4. The method of claim 2 further comprising receiving the generated second I/O request at the file system and determining at the file system that the unique location of the received second I/O request does not have any redirection device corresponding thereto, and based thereon honoring the received second I/O request at the file system by opening the file at the unique location of the host as specified in the second I/O request and returning a handle to the opened file at the unique location to the particular copy of the legacy application.

5. The method of claim 4 further comprising the particular copy of the application employing the handle to access the file at the unique location.

6. The method of claim 1 comprising determining the unique location as a branch of the identified alternate location, the branch having the identified unique ID as the name thereof.

7. The method of claim 1 further comprising receiving the re-issued data request and determining that the unique location of the re-issued data request does not have any redirection device corresponding thereto, and based thereon honoring the re-issued data request by opening the file at the unique location of the host as specified in the re-issued data request and returning a handle to the opened file at the unique location to the particular copy of the legacy application.

8. The method of claim 7 further comprising the particular copy of the application employing the handle to access the file at the unique location.

9. The method of claim 1 comprising altering the requested location of the file from the absolute location to the unique location without notifying the particular copy of the legacy application of such alteration.

10. The method of claim 1 comprising determining that the absolute location of the data request has a redirection device corresponding thereto, the redirection device being selected from a reparse point attached to the absolute location and redirection information corresponding to the absolute location as obtained from a conversion table.

11. A method with regard to a host computing device having a plurality of instantiated copies of a legacy application thereon, each copy of the legacy application being in a differing workspace and having a unique ID associated therewith, each copy of the legacy application at least potentially issuing a data request to access data at an absolute location of the host common to all of the copies of the legacy application at the host, the method for responding to the data request from a particular copy of the legacy application having a particular unique ID and comprising:
determining that the absolute location of the data request has a redirection device corresponding thereto, the redirection device specifying an alternate location of the host that is to be employed instead of the absolute location;
dishonoring the data request based on the redirection device;
determining a unique location of the host based on the alternate location of the redirection device and the particular unique ID of the particular copy of the legacy application; and
re-issuing the data request to access the data at the unique location of the host,
whereby for each different instantiated copy of the legacy application at the host, data requests therefrom are not directed to the same absolute location but instead to the unique location that corresponds to the copy.

12. The method of claim 11 comprising:
generating a first I/O request corresponding to the data request at an I/O manager, the first I/O request including an identification of the data and the absolute location thereof from the data request;
receiving the generated first I/O request at a data access system and determining at the data access system that the absolute location of the received first I/O request has a redirection device corresponding thereto, the redirection device specifying an alternate location of the host that is to be employed instead of the absolute location;
dishonoring the received first I/O request at the data access system based on the redirection device corresponding to the absolute location of the received first I/O request, and returning a redirection response including the alternate location of the redirection device;
receiving the returned redirection response at a fanning filter, identifying at the fanning filter the alternate location in the received redirection response, and also identifying the particular unique ID of the particular copy of the legacy application that issued the data request;
determining at the fanning filter a unique location of the host based on the identified alternate location and the identified unique ID, and passing the determined unique location to the I/O manager as a request to ignore the first I/O request and instead generate a second I/O request based on the first I/O request; and
generating at the I/O manager the second I/O request to include the identification of the data and the unique location;
whereby for each different instantiated copy of the legacy application at the host, data requests therefrom are not directed to the same absolute location but instead to the unique location that corresponds to the copy.

13. The method of claim 12 comprising determining at the fanning filter the unique location as a branch of the identified alternate location, the branch having the identified unique ID as the name thereof.

14. The method of claim 12 further comprising receiving the generated second I/O request at the data access system and determining at the data access system that the unique location of the received second I/O request does not have any redirection device corresponding thereto, and based thereon honoring the received second I/O request at the data access system by opening access to the data at the unique location of the host as specified in the second I/O request and returning a handle to the data at the unique location to the particular copy of the legacy application.

15. The method of claim 14 further comprising the particular copy of the application employing the handle to access the data at the unique location.

16. The method of claim 11 comprising determining the unique location as a branch of the identified alternate location, the branch having the identified unique ID as the name thereof.

17. The method of claim 11 further comprising receiving the re-issued data request and determining that the unique location of the re-issued data request does not have any redirection device corresponding thereto, and based thereon honoring the re-issued data request by opening access to the data at the unique location of the host as specified in the re-issued data request and returning a handle to the data at the unique location to the particular copy of the legacy application.

18. The method of claim 17 further comprising the particular copy of the application employing the handle to access the file at the unique location.

19. The method of claim 11 comprising altering the requested location of the data from the absolute location to the unique location without notifying the particular copy of the legacy application of such alteration.

20. The method of claim 11 wherein the requested data is in one of a data store and a registry, the method comprising determining that the absolute location of the data request has a redirection device corresponding thereto, the redirection device being redirection information corresponding to the absolute location as obtained from a conversion table.
